(19) United States
(12) Patent Application Publication
(10) Pub. No.: US 2005/0132300 A1
(43) Pub. Date: Jun. 16, 2005

(54) Calendar methods and systems

(76) Inventor: Jennifer A. Luhrs, Stillwater, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/997,517

(22) Filed: Nov. 24, 2004

Related U.S. Application Data
(60) Provisional application No. 60/525,533, filed on Nov. 26, 2003.

(51) Int. Cl. G06F 3/00; G06F 17/60

(52) U.S. Cl. 715/776; 715/963; 705/8

(57) ABSTRACT

The present invention provides color-codeable calendars/journals and systems. A calendar/journal system in accordance with the present invention includes a graphical color codeable key that can be used to visually associate a color with an act or event. The calendar/journal also includes a graphical module that represents a predetermined period of time. The graphical module can be color coded according to the color codeable key to indicated the occurrence of an act or event.

This application claims priority to U.S. Provisional Patent Application No. 60/525,533, filed Nov. 26, 2003, the entire contents of which is incorporated by reference herein for all purposes.

### FIELD OF THE PRESENT INVENTION

This present invention relates generally to calendars and/or journals that can be color coded by a user. More particularly, the present invention relates to user pre-defined color-codeable calendars and/or journals that may be used to track past actions and occurrences in a highly visible way.

### BACKGROUND OF THE PRESENT INVENTION

A journal typically is used to record actions, thoughts, or occurrences in a timely fashion, for later review or analysis, often with the aim of acquiring insight that can be used to effect improvement. A calendar can be used with a journal to correlate the entries in the journal to actual days of the calendar year.

One common way to record information in a journal is through the use of words or numbers. Numbers may be tallied to provide objective, meaningful analysis on a periodic basis and to easily identify trends. Dialogue or entries written in words are not easily quantified, however. Thus, it may be time-consuming or difficult to objectively identify trends over time. This is because recorded words usually need to be assigned some relative value or measurable component in order to conduct an analysis and form an objective opinion. As such it can be difficult to identify trends by using words alone.

### SUMMARY OF THE PRESENT INVENTION

The present invention provides color-codeable calendars/journals and systems that preferably include one or more of: (1) a daily module with pre-designated and undesignated subsections, (2) a color key correlating to the subsections of the daily module, (3) arrangement of seven of the daily modules into a weekly array of modules with a means of recording quantifiable weekly totals, (4) arrangement of four to six weekly arrays into a monthly calendar array or page with a means of recording quantifiable monthly totals, (5) arrangement of monthly calendar arrays or pages into an annual calendar array or booklet with a means of recording quantifiable annual totals and year-to-year totals.

In accordance with one aspect of the present invention, a calendar/journal preferably includes a collection of monthly calendar pages. Each day on the monthly calendar page preferably comprises a self-contained daily module with pre-designated and undesignated subsections capable of being filled in with color, and optionally, numbers or words. A designated sub-section might include a pre-printed date, for example. An undesignated subsection preferably comprises an area whose meaning and use the user can define via a monthly color key. The monthly color key preferably features an outline of the daily module with empty spaces next to it where the user can indicate which colors will be used in which subsections of the daily module to indicate user-defined actions or occurrences. Daily modules can be arranged in four to six rows of seven modules with an area at the end of each row for optionally tallying quantifiable data for the week. At the end of the month there can be an area for tallying quantifiable totals. Other areas on the page may contain written information, instructions, or other visual ways to quickly gauge progress or behavioral changes.

At the beginning of each month a user preferably populates a color key with colors that correlate user-selected subsections of the daily module with behavior change or other actions or occurrences that the user wishes to track and analyze in a visual manner using a variety of colors. On a more or less daily basis throughout the month, the user preferably colors or otherwise marks the sections of the daily modules to reflect daily activity as specified in the color key. Optionally, the user may also enter alphanumeric data for later quantification and analysis. At the end of the month the user can review the pattern and trends represented by the colors and alphanumeric data and preferably adjusts the color key for the following month, gathering and tracking data throughout the entire year and through subsequent years.

In accordance with other aspects of the present invention, a calendar of the present invention may be printed on paper in any commonly found calendar variations such as wall calendars, compact calendars, desk calendars, calendar blotters, planners, pocket calendars, cube calendars, poster calendars, or the like. Various components of the calendar may be printed and offered separately in other forms. For example, the daily modules may be printed separately on plain paper or repositionable note paper for later attachment or entry on a monthly calendar. Any number of daily modules such as a week of daily modules may be printed separately on plain paper or repositionable note paper for later attachment or entry on the monthly calendar. Alternatively, week or day modules can be provided as stickers that can be placed on an existing calendar. Certain months or portions of the year may be printed and bound separately. A calendar may be printed in card form with colorful sliding plastic doors that open or close to show an action or occurrence. A calendar may also be printed in two sheets with die-cut windows that may be opened after certain actions or occurrences. A calendar may be printed on plastic or other materials with erasable surfaces, if desired.

Any of the described paper calendar systems may be used alone or in combination with a wide variety of electronic systems and processes. More specifically, a tracking system of the present invention may be provided electronically either online, via computer software, by PDA, telephone, or some combination of any of these. Electronic delivery may be combined with use of printed versions of the calendars and may include electronic analysis of data originally collected on the printed calendars. A specially created or adapted graphics tablet may be used to simulate electronic “coloring in” of the modules for uploading to an electronic environment. Animated versions of the calendar and its components may be created and may include sound or other graphic or special effects. Online versions of the calendar may include extensive analysis and interactivity, including automated reminders and the opportunity to compete with others in individual or group challenges or the like. Three-dimensional forms of the calendar may be created with individual modules that are put together in a building block process or puzzle piece process to create a larger form.

The present invention provides many advantages. A color codeable calendar design of the present invention can make it easy to see accomplishments by quickly glancing at a particular page and noting the relative quantity of a particular color. Such calendars can also be beneficial to determine where more improvement is needed, and can even provide motivation to act in order to see less empty white space on the calendar. The calendars of the present invention can provide a convenient place to schedule future activities. The pleasurable activity of coloring in the modules provides an immediate reward and sense of recognition. If desired, additional rewards can be provided as goals are completed. Rewards, such as short-term rewards, can help motivate a user to make positive changes.

The calendars and systems of the present invention can also serve as a place to organize and keep track of actions and occurrences that are so small they might otherwise not be noted, but that are the building blocks for larger changes and improvement, and also important in establishing overall trends in order to determine where to effect improvement. Such calendars can make the user mindful of such actions, and helps the user internalize their locus of control over the actions and over the long-term results of those actions. By viewing the color and data which the user has personally entered, the user is more likely to trust the information and to be more objective and realistic about what has or hasn't been done, and what might need to be done.

Over time the user creates a permanent record of actions, data, occurrences and achievements that might otherwise have gone uncollected or unrecognized. This information can be important for many reasons. It provides the user with a sense of continuity through all their stages of change and a recognition that small daily actions do matter. In the case of health improvement, the user's perceived self-efficacy in making positive changes may be confirmed by looking back on past achievements and accomplishments, which may help motivate the user to continue improving or to attempt to make improvements or changes in other areas. The user may also look back and correlate health behaviors to life events, which could be useful in helping shape new responses to such events. The collected health data and health improvement information may also prove vitally useful to family and medical advisors in making medical decisions for or with the user.

Calendar systems and methods of the present invention can be used for individuals at any fitness level from beginners to elite athletes. Calendars can be customized for a particular user and/or class of users. For example, calendar systems may be customized for those who desire to quit smoking, lose weight, exercise more, drink less, and the like. The calendars and methods of the present invention can also include tips to get started and keep going for providing positive reinforcement, for example. Calendars and methods of the present invention can be used to visually show progress towards a goal, one day at a time, by using color to show what has been done. On a calendar of the present invention, a user can use color to show daily positive actions. Also, if desired, a user can use a predefined color to identify negative actions or the occurrence of some undesired event or the absence of performing some action. That is, what was actually accomplished as well as what was not accomplished can be illustrated, depending on the desires of a particular user. Calendars of the present invention can also include tips and instructions to help users get started and to help users continue toward their goals.

Over time, a user can create a colorful, one-of-a-kind mosaic that illustrates positive performance toward a goal. With just a quick glance back over such a colorful journal, a user can spot trends and see what worked on an individual basis. All that color can be like “a pat on the back” for the effort expended. Short-term rewards of this type can help motivate a user to make positive lifestyle changes.

A calendar in accordance with the present invention provides users with powerful behavioral support based on the processes of change used by people to move through the stages of change common to most health behaviors, as described in the Transtheoretical Model.

A calendar in accordance with the present invention helps trainers and advisors assess where users are in the health behavior change ‘stages of change’ model, in order to tailor communication and interaction with them for a more successful outcome. By assisting in consciousness raising, the calendar provides good support for people in the second stage of change (contemplation.)

In the preparation stage a person intends to take action within the next 30 days and has already taken some behavioral steps to do so. This stage is characterized by self-liberation, which includes a belief that they can change, and the commitment/recommitment to act on that belief, as typified by a New Year's resolution. With its monthly evaluation, goal and reward setting features, the calendar encourages users to make those commitments at any time of year and often throughout the year, as the small steps they take each day help them progress through many positive changes.

A calendar in accordance with the present invention provides reward mechanisms to support the action stage of the Transtheoretical Model of health behavior change, which lasts about six months, in which people are making improvements sufficient to reduce their risk of disease. The short-term and long-term rewards provides help support the contingency management aspect of successful health behavior change. Contingency management means that there will be consequences for actions. Most often rewards work better than punishments, and a calendar according to the present invention can provide daily, weekly, monthly and even longer term rewards.

Coloring in a calendar with that day's positive actions is an immediate reward. Unlike writing, which is a chore for many, coloring is associated with play and is considered a pleasant activity or reward. Coloring in each day on the calendar breaks any program down into small manageable steps, and gives people an immediate reward before they might notice it in their appearance or health. Seeing an accumulation of too many days without color provides a subtle ‘punishment’ that can motivate the person to take positive action.

The design of a daily module in accordance with the present invention makes it easy for a user to keep track of multiple health-related behaviors of their choosing, and improvement in one area may lead to a decision to try to improve in another. A calendar becomes a control panel for them to move through the stages of change in many behaviors and strengthen their sense of self-control.

In the maintenance stage, which lasts from roughly 6 months to 5 years, a user works to prevent relapse but is less tempted to relapse and increasingly confident of being able to maintain healthy behavior despite challenging situations (self-efficacy.) Contingency management and helping relationships of trainers and advisors who review such calendars are still important processes at this stage. Reviewing the calendar, which involves looking back over months and years of color that represents their positive actions to improve, is rewarding and can help bolster a user's confidence that they can continue to engage in healthy behavior.

### BRIEF DESCRIPTION OF THE DRAWINGS

The accompanying drawings, which are incorporated in and constitute a part of this application, illustrate several aspects of the present invention and together with a description of the embodiments serve to explain the principles of the present invention. A brief description of the drawings is as follows:

FIG. 1 is a schematic view of an exemplary monthly calendar page of the present invention showing a color key and plural individual day modules;

FIG. 2 is a schematic view of an exemplary color key of the present invention;

FIG. 3 is a schematic view of an exemplary day module of the present invention;

FIG. 4 is a schematic view of the day module of FIG. 3 showing information that has been recorded in the day module;

FIG. 5 is a schematic view of plural day modules of the present invention arranged to form a week module and showing information that has been recorded in certain of the day modules; and

FIG. 6 is an exemplary calendar of the present invention that includes plural monthly pages.

### DETAILED DESCRIPTION OF THE PREFERRED EMBODIMENT

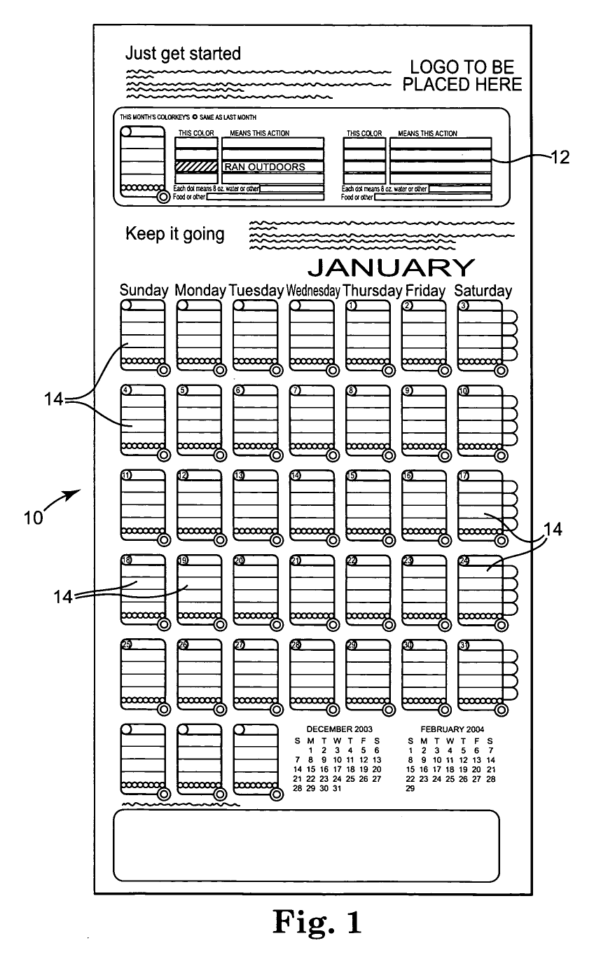

FIGS. 1-6 illustrate several examples of calendars and calendar features according to the present invention. These Figures show examples of how various components and features of the present invention may be arranged and used. It is contemplated that many variations may be made to the arrangements exemplified by the Figures, which are included within the scope of the present invention. In particular, FIG. 1 shows an exemplary monthly page 10 of a calendar of the present invention. As illustrated, the monthly page 10 preferably includes a monthly color key 12 and daily modules 14. As shown the key is placed at the top of the page but may be located anywhere on the page and may be on a separate page if desired. The day modules are arranged into weeks, as shown, but may be arranged in any way desired. For example, each day module, plural day modules, a week or plural weeks may be provided on a separate page, if desired. A monthly page may also include a goal/reward area, optional weekly/monthly totals, and/or tips to get started and keep going. Twelve monthly pages may be used to form a yearly calendar. Any number of monthly pages can be combined to form a calendar of the present invention. Such monthly pages may be printed on paper or the like or may be provided for electronic display and interaction such as on a web page or the like. Preferably, the background color for a monthly page is chosen so that colors used for the color key are visible and have contrast with respect to the background color. For example, monochromatic colors can be used.

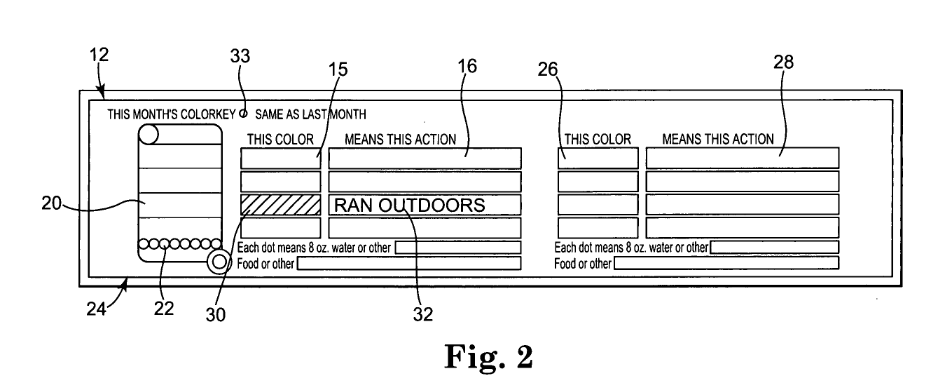

FIG. 2 shows an exemplary monthly color key 12 that can be used in accordance with the present invention. The color key can be provided in any way that allows a user to associate a color, symbol, or other graphical indicator or mark with an action or the like. The monthly color key 12 preferably includes a column of blank spaces or fields 15 that preferably correlate with an adjacent column of blank spaces of fields 16 in which a user can define certain actions or occurrences that can be tracked in the daily modules throughout the course of the month as described below. The placement of the blank spaces, 15 and 16, preferably corresponds roughly (vertically, as shown) to main sections 20 and subsections 22 of a representative daily module 24 that is preferably positioned on the color key 12. Because more than one color may be used in a section or subsection throughout the course of the month, an additional set of columns, 26 and 28, similar to columns 15 and 16 is preferably included adjacent to columns 15 and 16. Some of the fields, 15 and 16, maybe predefined for the user in terms of activity or occurrences tracked, but most are user defined such as shown with color code 30 and action 32. Optionally, the user may choose to specify the color key selections from the previous month by checking field 33.

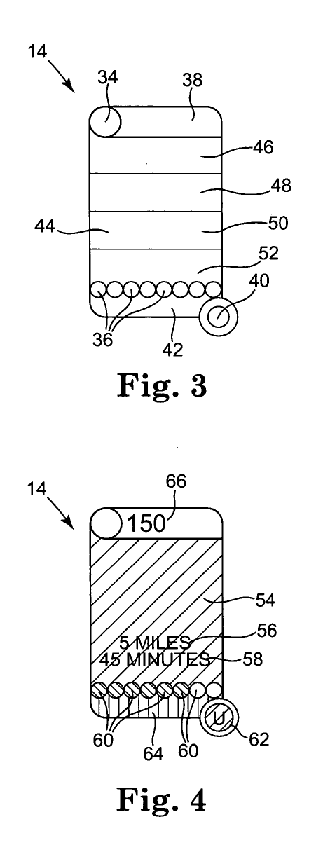

A daily module such as the daily module 14 shown in FIG. 3 preferably includes a pre-defined area 34 for the calendar date and an area or areas 36 to record or signify certain pre-defined actions or occurrences. For example, the areas 36 may be used to track how many glasses of water a user consumes for that particular day, where one area 36 would be filled in by the user after each glass of water is consumed. To provide the user with optimum flexibility to adapt and customize the daily module according to personal preferences, many discrete areas of the daily module are preferably left undefined such as areas 38, 40, and 42, for example. Also a section 44 may be used in its entirety or in subsections 46, 48, 50, and/or 52 as shown by dividing lines. Horizontal and/or vertical dividing lines may be used. Daily modules may be provided in any manner desired such that actions can be recorded with color. They can be any desired size and shape. They can be provided in paper or as an interactive electronic system. Any manner of providing color to the daily module may be used such as, marker, highlighters, pens, pencils, paints, inks, stickers, crayons, and the like. Also, electronic devices may be used such as those that can provide colored lights and the like to a daily module to indicate performance of an action in accordance with the present invention.

Preferably, the user enters colors or alphanumeric data into each daily module 14 throughout the course of the month to indicate occurrences or actions taken as shown in FIG. 4, for example. In the case of fitness improvement as shown in FIG. 4, the user can color the entire section 54 in a particular color to indicate an outdoor jog as is preferably specified in the color key and then can optionally add alphanumeric data indicating distance 56 and time 58. Water consumption can be indicated in a different color in predefined areas 60. Section 62 can be colored to indicate user performed resistance training on that day, and a symbol such as the letter “U” may be added to indicate upper body training, as other examples. The user may also define section 64 as an area in which to keep track of healthy food selections also indicated by various colors. Also, field 66 can be used to track weight or other desired parameter.

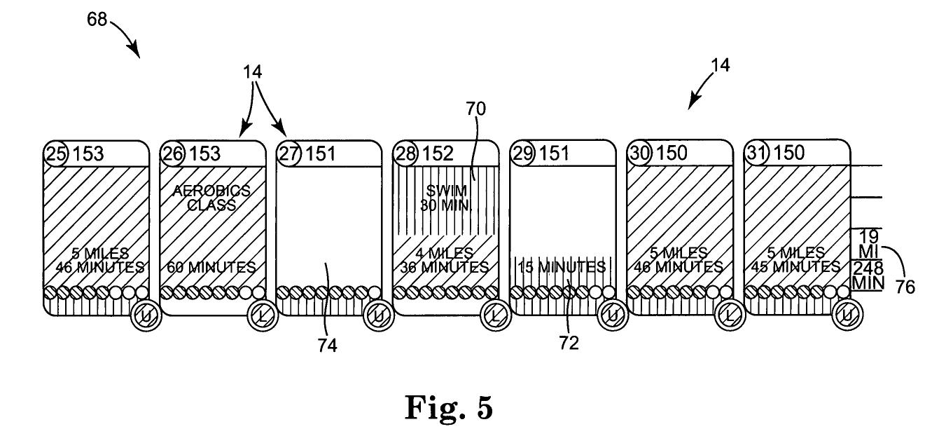

FIG. 5 shows an entire exemplary week 68 of daily modules 14 colored with various colors (indicated as cross-hatching or patterns) according to a user-defined color key and demonstrating customization by the user to indicate days with two different activities 70 (i.e., two different colors/cross-hatching), days with minimal activity 72 (i.e., days with a relatively large amount of “white space” or blank areas) and days with no exercise 74 which are readily apparent due to the lack of color. Optionally the user can tally weekly totals in spaces 76 provided at the end of each week.

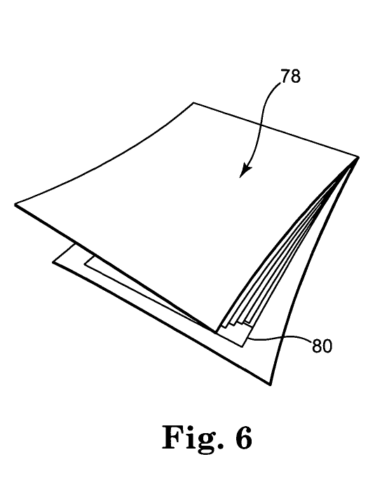

All of the monthly pages can be bound into a calendar form 78 as shown in FIG. 6, for example, and optionally year-end totals for user and subjective or objective data may be compared to previously collected baseline data for the user at the end of the calendar year or data collection period in a summary section 80. The calendar 78 may be bound in any desired way such as by spiral binding of the like.

Methods of the present invention can include steps of determining a goal such as one related to habits to improve, setting up a monthly color key, and coloring a calendar to indicate performance toward such goals.

As an example, one may desire to improve certain exercise habits. Accordingly, an exercise goal may be determined and set. For better health, exercising for 30 minutes per day on average may be a goal. For weight loss, exercising for 60 minutes per day on average may be a goal. Preferably, a user picks something they enjoy as an action. As such, it may be more likely that a user will stick with it. Also, those starting a new exercise program or those already on an exercise program may use such methods and calendars. Many activities can be used to set such goals. For example walking, running, stair climbing, swimming, biking, dancing, kickboxing, weight training, aerobics, yoga, gardening, team sports/activities, and the like may be used. Preferably, a user starts at a safe level for their current fitness level and health, and increases regularly and in small increments. Preferably, such exercise challenges a user somewhat (e.g. walking briskly rather than dawdling along). A user may consult with a fitness professional who can help the user identify weak points, and develop a cross-training program to help balance them out.

As described above, a calendar of the present invention preferably includes a monthly key that comprises a goal area where a user can set weekly goals and decide on a reward for reaching them by the end of the month, if desired. Typical goals might be “Walk to work three times a week” or “Exercise for 210 minutes per week” or “Run 12 miles per week,” or whatever activity, distance or duration is desired. This can also include diet or other goals such as generally health-related goals.

There may also be an area where a user can decide on a reward for fulfilling certain goals, if desired. A user may, for instance, decide to put away the money saved each day by not eating a certain unhealthy food item. At the end of the month, that money could be used to buy something new to wear, or some other desired item.

As another example, one may desire to improve certain eating habits. Accordingly, an eating habit goal(s) may be determined and set. For example, goals such as a candy-free day, donut-free day, soda pop-free day, white flour-free day, sugar-free day, fast food-free day, junk food-free day, did not eat anything 2 hours before bedtime, ate oatmeal, ate salmon or other source of omega-3 fatty acids, ate the recommended number of servings of fruits and vegetables, drank green tea, took vitamins, and the like, may be used. Other habits in the areas of eating, exercising, smoking, stress management and alcohol consumption can also be used to set goals.

Preferably, goals/actions are set forth in a positive way. Several examples include: alcohol-free day, smoke-free day, drank less caffeine, meditated, got adequate sleep, flossed my teeth, wore my seatbelt, or anything one can do to improve habits, or reduce risk of injury or illness.

A user can set up a monthly color key in any desired way. Users can decide where to use favorite colors. Preferably, color is used to show positive actions that a user can take, such as “walk around the lake” or “do my exercise video.” Preferably, a color key is not set up to show the outcomes/results actions (such as “lose 3 pounds”) because such results cannot generally be controlled each day. In months where a key is not changing, a user may just check a “same as last month” option, for example.

Calendars and systems of the present invention can be used in many different ways depending on a particular user. For example, a user can color a predetermined section of a daily module a bright yellow to show when the user took a walk outdoors. The user might also color a predetermined section green to show when the user took the stairs at work. And the user can keep track of eight-ounce glasses of water, perhaps in blue highlighter.

Users might want to keep track of weight such as by using a section right next to the date (See field 66 of the daily module 14 of FIG. 4, for example.). A user may decide to use color in that section to show days where they have not eaten a certain food they are trying to avoid. A user may also use color to show they added a healthy food item, or vitamins as described below.

A user who does more than one activity per day, can specify a different color in the main section for each activity. At the end of each day, the user can color the entire main section using many colors to represent multiple activities performed that day, using the dividing lines to separate activities.

As another example, for users doing regular resistance training, such a user can use the small circle in the lower right, and write in “U” for upper or “L” for lower body workouts or other symbol, or the like. Rest/recovery days are also positive and could be colored in and coded with an “R” or other symbol, or the like.

Weight and positive nutrition choices could also be noted in the space next to the date or any other space within a daily module, and a user can color in a spot to show the taking of vitamins or supplements.

A user can write in exercise distances, duration, frequency, or other sport-specific statistics, and total them up at the end of each week and each month. These totals can appear at the bottom of the page, making them easy to flip through and review.

Calendars of the present invention may also include one or more fields or locations to write down certain health statistics such as BMI, cholesterol, blood pressure and/or other user-selected measures/statistics before starting and at the end of some time period for comparison. For example, a user can track desired parameters weekly, monthly, quarterly, or yearly or on any other desired schedule. Also a place for before and after photos or written comments may be provided, if desired.

The present invention has now been described with reference to certain specific embodiments. The foregoing detailed description has been given for clarity of understanding. Others may recognize that changes can be made in the described embodiments without departing from the scope and spirit of the present invention. Thus, the scope of the present invention should not be limited to the exact details and structures described herein.

1. A color-based system for recording information related to a user, the system comprising at least one user-viewable color key that can be color coded to associate one or more predetermined colors with predetermined information related to a user and one or more user-viewable modules that each represents a predetermined period of time, wherein the one or more user-viewable modules are color-codeable according to the user-viewable color key to indicate a predetermined relationship between the information related to the user and the predetermined period of time represented by the user-viewable module.

2. The system of claim 1, wherein the one or more user-viewable modules represents a day.

3. The system of claim 1, wherein a plurality of user-viewable modules are arranged to represent a week.

4. The system of claim 1, wherein a plurality of user-viewable modules are arranged to represent a month.

5. The system of claim 1, wherein a plurality of user-viewable modules are arranged to form a calendar.

6. The system of claim 1, wherein the color key comprises a plurality of user definable fields that each correspond with a plurality of color codeable fields of each of the one or more user-viewable modules.

7. The system of claim 1, wherein the user-viewable color key and the one or more user-viewable modules are simultaneously viewable by a user.

8. The system of claim 7, wherein the user-viewable color key and the one or more user-viewable modules are provided on a page of a calendar.

9. A method for recording information related to a user, the method comprising the steps of:
assigning one or more predetermined colors with information related to a user to form a graphical color key;
providing one or more graphical modules, each graphical module representing a predetermined period of time; and
color-coding the one or more graphical modules according to the graphical color key based on the information related to the user to visually indicate a predetermined relationship between the information related to the user and the predetermined period of time represented by the user-viewable module.

10. The method of claim 9, wherein the information related to a user comprises information related to a health related goal.

11. The method of claim 9, wherein the information related to a user comprises information related to a habit related goal.

12. The method of claim 9, comprising visually tracking the information related to a user by observing a plurality of color coded graphical modules.

13. The method of claim 12, comprising setting a goal related to the information related to a user.

14. The method of claim 9, comprising arranging a plurality of graphical modules to form a calendar.

15. A method of using a calendar system, the method comprising the steps of:
providing a calendar that comprises one or more graphical modules, each graphical module representing a predetermined period of time, and a graphical key that can be color coded;
color coding the graphical key by assigning one or more predetermined colors with information related to a user; and
color-coding the one or more graphical modules according to the color coded graphical key based on the information related to the user to visually indicate a predetermined relationship between the information related to the user and the predetermined period of time represented by the user-viewable module.

16. The method of claim 15, wherein the information related to a user comprises information related to a health related goal.

17. The method of claim 15, wherein the information related to a user comprises information related to a habit related goal.

18. The method of claim 15, comprising visually tracking the information related to a user by observing a plurality of color coded graphical modules.

19. The method of claim 18, comprising setting a goal related to the information related to a user.

20. The method of claim 15, wherein color-coding the one or more graphical modules comprises using a predetermined color to indicate the occurrence or non-occurrence of an act or event.
